(19) United States
(12) Patent Application Publication
(10) Pub. No.: US 2018/0302622 A1
(43) Pub. Date: Oct. 18, 2018

(54) Image Compression Based on Distance Information

(71) Applicant: Apple Inc., Cupertino, CA (US)

(72) Inventors: David T. Wooden, Mountain View, CA (US); Luciano Spinello, Sunnyvale, CA (US)

(21) Appl. No.: 15/950,384

(22) Filed: Apr. 11, 2018

Related U.S. Application Data
(60) Provisional application No. 62/484,530, filed on Apr. 12, 2017.

(51) Int. Cl. H04N 19/124; H04N 19/11; H04N 19/176; H04N 19/182; H04N 19/186

(52) U.S. Cl. CPC H04N 19/124; H04N 19/11; H04N 19/186; H04N 19/182; H04N 19/176

(57) ABSTRACT

A method includes determining compression parameters for image portions based on a distance value for each of the image portions such that compression rates applied by the compression parameters depend on the distance values, and encoding the image portions using the compression parameters. The range-based compression parameters cause the image portions corresponding to large distance values to be compressed using low compression rates and cause the image portions corresponding to small distance values to be compressed using high compression rates.

### CROSS-REFERENCE TO RELATED APPLICATIONS

This application claims the benefit of U.S. Provisional Application No. 62/484,530, entitled “Image Compression Based on Distance Information,” filed on Apr. 12, 2017, the content of which is incorporated herein by reference for all purposes.

### TECHNICAL FIELD

The application relates generally to image compression.

### BACKGROUND

Images, such as still images or video images, can be utilized as inputs to control automated systems. Machine vision refers broadly to techniques and processes for identifying features in images

In some machine vision applications, image information is used to extract geometric features. Image information may be obtained and annotated to train machine learning models to recognize features in still images or video images. In some applications, large amounts of image information are utilized for training purposes. If a mobile apparatus, such as a vehicle, is utilized to obtain image information, the amount of storage space available for image storage may be limited. Image compression techniques can be utilized to reduce the amount of storage space consumed by a still image or by a segment of a video.

### SUMMARY

One aspect of the disclosed embodiments is a method that includes determining compression parameters for image portions based on a distance value for each of the image portions such that compression rates applied by the compression parameters depend on the distance values, and encoding the image portions using the compression parameters. The range-based compression parameters cause the image portions corresponding to large distance values to be compressed using low compression rates and cause the image portions corresponding to small distance values to be compressed using high compression rates.

Another aspect of the disclosed embodiments is a method that includes obtaining an image, obtaining range information, defining image portions from the image, correlating the range information to the image portions to define correlated range values that each describe a distance that is associated with a respective one of the image portions, and encoding the image to generate an encoded image. Encoding the image is performed using compression parameters for at least some of the image portions to apply a high compression rate to at least some of the image portions having correlated range values that correspond to short distances and to apply a low compression rate for at least some of the some of the image portions having correlated range values that correspond to long distances.

Another aspect of the disclosed embodiments is a method that includes obtaining an image, obtaining range information, defining image portions from the image, identifying a first group of image portions from the image portions and a second group of image portions from the image portions, correlating the range information to the image portions in the first group of image portions to define correlated range values that each describe a distance that is associated with a respective one of the image portions, determining range-based compression parameters for the image portions in the first group of image portions based on the correlated range values, and encoding the image portions using the range-based compression parameters for the first group of image portions to generate an encoded image.

### BRIEF DESCRIPTION OF THE DRAWINGS

FIG. 1 is a block diagram showing a system for image compression based on distance information.

FIGS. 2A and 2B are illustrations that show examples of correlating image portions with range information.

FIG. 3 is an illustration that shows an example of a system for image compression based on distance information that is implemented in a vehicle.

FIG. 4 is an illustration that shows an example of a hardware configuration of a computing device.

FIG. 5 is a flowchart that shows an example of a process for image compression based on distance information.

FIG. 6 is a functional block diagram showing an apparatus.

### DETAILED DESCRIPTION

The disclosure herein is directed to image compression techniques that utilize distance information to determine quality-related settings. Image compression techniques typically cause some degree of loss of detail in the compressed still image or video relative to the original still image or video. When the still image or video is intended for use in machine vision applications, a high degree of loss of detail may limit the ability of the machine vision application to recognize features in the application. As a result of the need to preserve detail for the machine vision application, the degree of compression that can be applied is limited.

The systems and methods described herein implement image compression based on distance information. Sensors are used to obtain an image and distance information. The image is compressed using the distance information by spatially correlating portions of the image to the distance information such that the visible content of the image and the distance information represent the same area, objects, or features in the environment around the system. Using the correlated range information, a still image encoder or a video encoder is controlled to apply higher compression rates to areas of the image that are close to the sensors, and to apply lower rates of compression to areas of the image that are far from the sensors. This allows more spatial detail and/or chromatic detail to be preserved for far away objects, which are represented by fewer pixels in the image than close objects, while reducing file sizes by heavily compressing portions of the image that correspond to close objects.

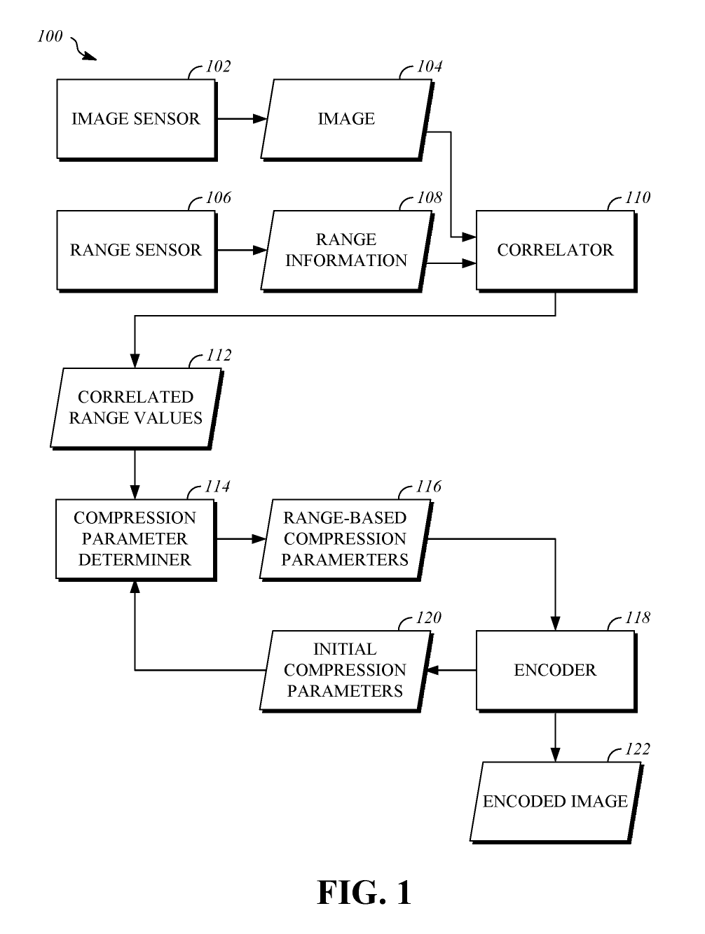

FIG. 1 is a block diagram showing a system 100 for image compression based on distance information. The system 100 may be implemented, in part, using a computing device of any type, such as a computing device that includes a memory, a processor, and program instructions that are stored in the memory and cause the processor to perform actions when executed.

The system 100 includes an image sensor 102 that generates an image 104 as an output. The image sensor 102 may be any type of sensor that is operable to generate information (e.g. signals or data) in response to visible light that is incident upon a portion of the sensor. The information generated by the image sensor 102 is in the form of a two-dimensional array having x and y dimensions that correspond to a field of view of the image sensor 102. The image sensor 102 can be a still image camera that is operable to generate information that represents an individual image, or the image sensor 102 can be a video camera that is operable to generate information that represents a sequence of successive images. As examples, the image sensor 102 may include sensing elements that utilize complementary metal-oxide-semiconductor (CMOS) sensing elements, charge-coupled device (CCD) sensing elements, or sensing elements that employ other technologies and are operable to generate information in response to visible light.

The image 104 may be in any format that can be interpreted to form and display a visually perceptible image. As one example, the image 104 may be raw data representing signals from individual sensing elements of the image sensor 102. As another example, the image 104 may be uncompressed image data that has been encoded into values representing image elements, such as component values that represent pixels. As another example, the image 104 may be encoded and compressed image data. The image 104 may also include information that indicates when the image was generated, such as a timestamp.

The system 100 includes a range sensor 106 that generates range information 108. The range information indicates distance between the range sensor 106 and objects near the range sensor, and may generate multiple distance values corresponding to different locations or portions within a field of view of the range sensor 106. Range information may also be referred to herein as distance information.

The range sensor 106 is located near the image sensor 102. The image sensor 102 and the range sensor 106 are oriented such that the field of view of the image sensor 102 overlaps a field of view of the range sensor 106. Because the fields of view of the image sensor 102 and the range sensor 106 overlap, it is possible to determine a spatial correlation between portions of the image 104 that is generated by the image sensor 102, and individual range values from the range information 108 that is generated by the range sensor 106.

The range sensor 106 can be any type of sensor that is able to generate information that indicates that distance from the sensor to objects in the environment surrounding the sensor. As examples, the range sensor 106 can be a LIDAR sensor, a RADAR sensor, a laser range sensor, a stereoscopic sensor, or any other type of sensor that is able to generate information that indicates that distance from the sensor to objects in the environment.

The range information 108 generated by the range sensor 106 includes numerous values that each correspond to a spatial location within the field of view of the range sensor 106. For example, the range information 108 may include sets of values that each correspond to a spatial location, with each set of values including one or more location values that identify the location, such as in x and y coordinates, and including one or more range values that indicate the distance of the range sensor 106 from of an object that is present at the spatial location specified by the location values. As an example, the range information 108 may be in the form of a two-dimensional array having an x dimension and a y dimension that correspond to locations a field of view of the range sensor 106, and range values for each location. The range information 108 may also include information that indicates when the information was generated, such as a timestamp.

The image 104 and the range information 108 are provided to a correlator 110 as inputs. The image 104 and the range information 108 can also be provided to components of other systems as inputs. The image 104 and the range information 108 can be provided to the correlator 110 directly by the image sensor 102 and the range sensor 106, or the image 104 and the range information 108 can be provided to the correlating unit after processing and/or storage by other components.

The correlator 110 utilizes the image 104 and the range information 108 to determine correlated range values 112 that each correspond to a portion of the image 104. The correlator 110 performs a temporal correlation operation, and a spatial correlation operation.

The portion of the image 104 can be, for example, a grouping of pixels such as a square grouping of pixels or a rectangular grouping of pixels. As an example, each portion of the image 104 can correspond to a block or a macroblock of the image 104 subsequent to encoding.

The image 104 and the range information 108 are first temporally correlated such that the values from each represent information gathered close in time. As one example, from among multiple images and multiple sets of range values, each corresponding to a certain point in time, the image 104 and the range information 108 can be identified as temporally correlated based on a minimal difference in the timestamp of the image 104 relative to the timestamp of the range information 108. As another example, the image 104 and the range information 108 can be identified as temporally correlated if the timestamp of the image 104 and the timestamp of the range information 108 differ by less than a threshold value.

Portions of the image 104 and values from the range information 108 are spatially correlated such that the values represent similar spatial locations in the environment surrounding the image sensor 102 and the range sensor 106. The result of spatially correlating values can be the correlated range values 112, which each correspond to a specified portion of the image 104. The range information 108 may or may not include range values for all portions of the image 104, dependent upon, for example, the field of view of the image sensor 102 relative to the field of view of the range sensor 106 and the maximum sensing distance of the range sensor 106.

Well known geometric techniques can be utilized to spatially correlate the image 104 and the range information 108. As one example, a predetermined spatial relationship mapping can be used to determine locations in the image 104 that correspond to range values from the range information 108. As another example, geometric information for the image sensor 102 and the range sensor 106 can be used to calculate correspondence of locations in the image to range values from the range information 108. The geometric information may describe, as examples, the positions, angular orientations, and field of view angles for the image sensor 102 and the range sensor 106.

In some implementations, the original range values from the range information 108 may have other than a one-to-one correspondence to the portions of the image 104. If none of the original range values spatially correspond (e.g., are located within) a specified portion of the image 104, the correlated range value 112 for that portion of the image 104 can be interpolated based on two or more range values from other portions of the image 104 such as from adjacent portions of the image 104.

If two or more of the original range values spatially correspond (e.g., are located within) a specified portion of the image 104, the correlated range value 112 for that portion of the image 104 can be determined as an average of the original range values or as a distance-weighted average of the original range values based on respective distances from the center of the specified portion of the image 104.

The output of the correlator 110, including correlated range values 112 that each correspond to a specified portion of the image 104, is provided to a compression parameter determiner 114 as an input. The compression parameter determiner 114 determines range-based compression parameters 116 for the image 104 on a portion-by-portion basis, based on the correlated range values 112 for each portion of the image 104.

The range-based compression parameters 116 control operation of an encoder 118, and control how compression is applied to each portion of the image 104. The range-based compression parameters 116 affect the amount of data utilized to encode each portion of the image 104, which is related to the quality of the portion of the image 104 subsequent to encoding.

The range-based compression parameters 116 are determined by the compression parameter determiner 114 such that higher rates of compression are applied to areas of the image 104 that correspond to objects that are located near the image sensor 102, based on the correlated range values 112. Applying high rates of compression to objects that are located near the image sensor 102 allows greater compression of images, while allowing feature recognition and other machine vision techniques to be performed, as objects near the image sensor 102 will be represented by more pixels in the image 104. The range-based compression parameters 116 are determined by the compression parameter determiner 114 such that lower rates of compression are applied to portions of the image 104 that represent objects that are located far from the image sensor 102, based on the correlated range values 112.

In some implementations, the process of applying high compression rates to near objects and low compression rates to far objects can be applied to only a portion of the image 104. As one example, applying high compression rates to near objects and low compression rates to far objects can be applied to portions of the image 104 for which the range information 108 is available, and a different value or value determining method can be used for portions of the image 104 for which the range information 108 is not available. As another example, portions of the image 104 can be selected for applying high compression rates to near objects and low compression rates to far objects based on features that are identified in the image, such as by identifying a portion of the image 104 as corresponding to the sky and excluding that portion from range-dependent compression processing, and instead using a different value or value determining method for the excluded portions of the image 104.

As one example, the range-based compression parameters 116 that are determined by the compression parameter determiner 114 may be quantization parameters. Quantization is a technique used in compression to allowing higher rates of compression by reducing the number of discrete values. Values within a certain range are quantized by changing all of them to a single value. Quantization parameters control the size of the range of values that will be reduced to a single value. Low quantization parameter values corresponding to small ranges and small reductions in the number of discrete values used. High quantization parameter values correspond to large ranges and large reductions in the number of discrete values used. In image compression, quantization is a lossy process that causes a reduction in the amount of spatial detail or chromatic detail that is present in an image. Low quantization parameter values cause a low amount of spatial detail loss or chromatic detail loss, while high quantization parameter values cause a high amount of spatial detail loss or chromatic detail loss.

As another example, the range-based compression parameters 116 that are determined by the compression parameter determiner 114 may dictate the spatial pixel resolution used to encode areas of the image 104. For instance, the image portions could be divided into two or more groups or regions based on the correlated range values 112, with different spatial resolutions utilized to encode each of the groups or regions.

The compression parameter determiner 114 can determine the range-based compression parameters 116 without receiving information from the encoder 118. As one example, the range-based compression parameters 116 for each portion of the image 104 can be scaled between a first value and a second value based on the correlated range value 112. The first and second values can correspond to minimum or maximum allowable values for the range-based compression parameters 116, or may be selected values that are between the minimum and maximum allowable values for the range-based compression parameters 116. Using quantization parameters as an example, the quantization parameters can be determined dependent on the correlated range values 112, such as by scaling between first and second values quantization parameter values can be performed inverse to the correlated range values 112, with the highest correlated range values 112 corresponding to the lowest quantization parameter values, which produce high levels of spatial detail and chromatic detail, and the lowest correlated range values 112 corresponding to the highest quantization parameter values, which produce low levels of spatial detail and chromatic detail.

The compression parameter determiner 114 can determine the range-based compression parameters 116 based on information received from the encoder 118. As one example, the encoder 118 can analyze the image, such as in an initial coding pass, and output initial compression parameters 120 for portions or regions of the image 104. Based on the correlated range values 112 for the portions of the image 104, the initial compression parameters 120 can be changed by the compression parameter determiner 114 to generate the range-based compression parameters 116. The range-based compression parameters 116 values are provided to the encoder 118 by the compression parameter determiner 114 for use in encoding the image 104.

Three types of adjustments can be made to generate the range-based compression parameters 116 from the initial compression parameters 120 based on the correlated range values 112. The first adjustment type does not change the initial compression parameters 120 for portions or regions of the image 104 having high correlated range values 112, and changes the initial compression parameters 120 to increase compression rates as the correlated range values 112 decrease. Thus, the first adjustment type may maintain the amount of compression applied to objects far from the image sensor 102, moderately increase the amount of compression applied to objects at an intermediate distance from the image sensor 102, and greatly increase the amount of compression applied to objects that are near from the image sensor 102.

The second adjustment type does not change the initial compression parameters 120 for portions or regions of the image having low correlated range values 112, and changes the initial compression parameters 120 to decrease compression rates as the correlated range values 112 increase. Thus, the second adjustment type may maintain the amount of compression applied to objects near the image sensor 102, moderately decrease the amount of compression applied to objects at an intermediate distance from the image sensor 102, and greatly decrease the amount of compression applied to objects that are far from the image sensor 102.

The third adjustment type changes the initial compression parameters 120 to increase compression rates for portions or regions of the image 104 having low correlated range values 112, and to decrease compression rates for portions of regions of the image 104 having high correlated range values 112. Thus, the third adjustment type may increase the amount of compression applied to objects near the image sensor 102, apply little or no change in the amount of compression applied to objects at an intermediate distance from the image sensor 102, and decrease the amount of compression applied to objects that are far from the image sensor 102. Although specific examples are given with respect to different modifications discussed herein such as modification by scaling and modification by adjustment factors, all three adjustment types can be utilized with these modifications.

The initial compression parameters 120 are provided to the compression parameter determiner 114 and are modified on a portion-by-portion basis based on the correlated range values 112. As one example, the initial compression parameters 120 can be scaled up or down for each portion of the image 104 based on the correlated range value 112 for the respective portion of the image 104. With quantization parameters as an example, a scaling factor can be determined dependent on the correlated range values 112, such as inversely to the correlated range values 112. A range value can be set as a neutral point at which no change as applied to the initial compression parameters 120. By setting the neutral value to correspond to an intermediate range, a positive scaling factor would result for low correlated range values 112 to increase the quantization parameter applied to those portions of the image 104, and a negative scaling factor would result for high correlated range values 112 to decrease the quantization parameter applied to those portions of the image 104. Thus, the highest correlated range values 112 will correspond to the lowest quantization parameter values, which produce high levels of spatial detail and chromatic detail, and the lowest correlated range values 112 will correspond to the highest quantization parameter values, which produce low levels of spatial detail and chromatic detail.

As another example, an adjustment factor can be calculated for each portion of the image 104 based on the correlated range values 112 to increase, decrease, or maintain the amount of compression represented by the initial compression parameters 120 provided by the encoder 118. The adjustment factor is dependent on the correlated range values 112. The adjustment factor can be inverse to the correlated range values 112 such that, for example, the adjustment factor increases the initial value of the quantization parameter for portions of the image 104 having a low correlated range value 112 and such that the adjustment factor decreases the initial value of the quantization parameter for portions of the image 104 having a high correlated range value 112.

The encoder 118 receives the image 104 as an input and also receives range-based compression parameters 116 from the compression parameter determiner 114 as an input. As previously described, the encoder 118 may determine the initial compression parameters 120, such as quantization parameter values, provide the initial compression parameters 120 to the compression parameter determiner 114, and then receive the range-based compression parameters 116 from the compression parameter determiner 114 subsequent to determination of the range-based compression parameters 116 by the compression parameter determiner 114 based on the correlated range values 112.

Using the range-based compression parameters 116, the encoder 118 processes the image 104, compresses the image 104 according to a compression standard, and generates an encoded image 122 as an output. The encoder 118 can be a still image compression standard or a video compression standard. One example of a video compression standard that can be used in the encoder 118 to implement the system 100 is the H.265 video compression standard. Any still image or video compression standard can, however, be utilized in the encoder 118 to implement the system 100. The output of the encoder 118 is the encoded image 122, which may be a still image or a video frame from a sequence of video frames. The encoded image 122 may be utilized in another process, stored for subsequent use, or transmitted to another system for use or storage.

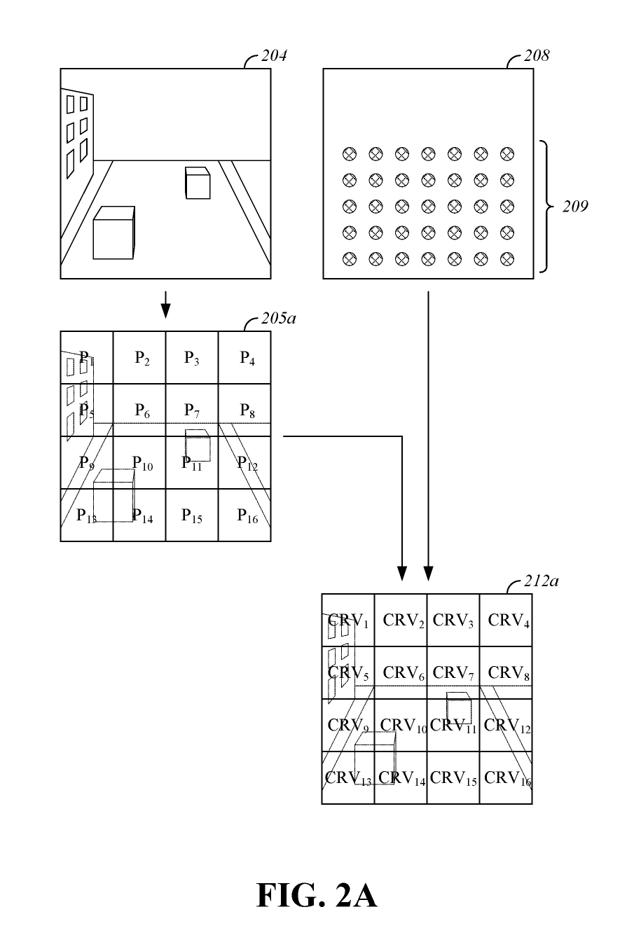

FIG. 2A is an illustration that shows an example of correlating image portions with range information. An image 204 is obtained, as explained with respect to the image sensor 102 and the image 104. The image 204 is divided into image portions 205a, including individual image portions P1-P16. The image portions 205a can, for example, correspond to blocks or macroblocks. Range information 208 is obtained, as explained with respect to the range sensor 106 and the range information 108. The range information 208 can include individual range values 209.

The range information 208 is correlated with the image 204 in the manner described with respect to the correlator 110 to generate correlated range values 212a, which are similar to correlated range values 112. Individual correlated range values CRV1-CRV16 are determined on a per-portion basis for each of the individual image portions P1-P16. As previously described, the correlated range values 112 can be determined for each of the individual image portions P1-P16 by averaging or interpolation using the correlated range values 212.

In the illustrated example, no correlated range information may be available for correlated range values CRV1-CRV4 due to absence of individual range values 209 in and around individual image portions P1-P4. Absence of range information in these areas can be caused, for example, by the objects in the corresponding areas of the image 204 being outside of the range of the sensors used to obtain the range information 208. Correlated range values CRV5-CRV8 in the illustrated example correspond to far distances, and are compressed mildly, as described with respect to the compression parameter determiner 114 and the encoder 118. Correlated range values CRV9-CRV12 in the illustrated example correspond to medium distances, and are compressed moderately, as described with respect to the compression parameter determiner 114 and the encoder 118. Correlated range values CRV13-CRV16 in the illustrated example correspond to short distances, and are compressed highly, as described with respect to the compression parameter determiner 114 and the encoder 118.

FIG. 2B is an illustration that shows a second example of correlating image portions with range information. The range information 208 is obtained, including the individual range values 209, as previously described. The range information 208 is utilized to divide the image 203 into image portions 205b based on the range values 209. For example, the range values 209 can be utilized to define areas in which the individual range values 209 are similar. As one example, these areas can be defined based on determining that range values within the area differ by less than a threshold value, where the threshold value is either a static value or a dynamically determined value. As another example, these areas can be determined using a clustering algorithm. These areas are utilized to define the image portions 205b, including individual image portions P1-P12. The image portions 205b can be areas of any shape or size, such as rectangular, square, or irregular, where each of the individual image portions P1-P12 represents an area in which the individual range values are similar.

The range information 208 is correlated with the image 204 in the manner described with respect to the correlation module 110 to generate correlated range values 212b, which are similar to correlated range values 112. Individual correlated range values CRV1-CRV12 are determined on a per-portion basis for each of the individual image portions P1-P12. As previously described, the correlated range values 112 can be determined for each of the individual image portions P1-P12 by averaging or interpolation using the correlated range values 212b.

In the illustrated example, no correlated range information may be available for the correlated range value CRV1 due to absence of individual range values 209 in and around individual image portion P1. Absence of range information in these areas can be caused, for example, by the objects in the corresponding areas of the image 204 being outside of the range of the sensors used to obtain the range information 208. Correlated range values CRV3, CRV5, CRV6, and CRV7 in the illustrated example correspond to far distances, and are compressed mildly, as described with respect to the compression parameter module 114 and the encoder 118. Correlated range values CRV2, CRV4, CRV8, and CRV10 in the illustrated example correspond to medium distances, and are compressed moderately, as described with respect to the compression parameter module 114 and the encoder 118. Correlated range values CRV9, CRV11, and CRV12 in the illustrated example correspond to short distances, and these areas are compressed highly, as described with respect to the compression parameter module 114 and the encoder 118.

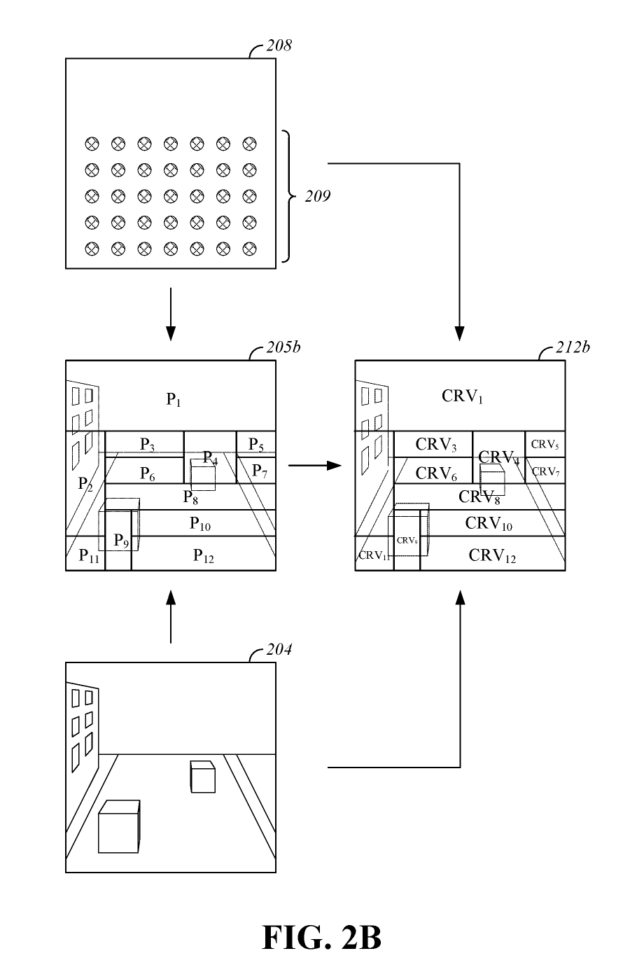

FIG. 3 is an illustration that shows an example of a system 300 for image compression based on distance information that is implemented in a vehicle 301. The system 300 implements image compression based on distance information as described with respect to the system 100. The system 300 includes an image sensor 302 and a range sensor 306. The image sensor 302 and the range sensor 306 are supported by the vehicle 301 and are oriented such that an image sensor field of view 303 of the image sensor 302 and a range sensor field of view 307 of the range sensor 306 at least partially overlap and are oriented toward an area of interest, such as a roadway 324 that is located ahead of the vehicle 301 relative to an intended direction of travel of the vehicle 301. Information from the image sensor 302 and the range sensor 306 are provided to a computing device 326 that is operable to process and store the information in the manner described with respect to the system 100, including the functions described with respect to the correlator 110, the compression parameter determiner 114, and the encoder 118.

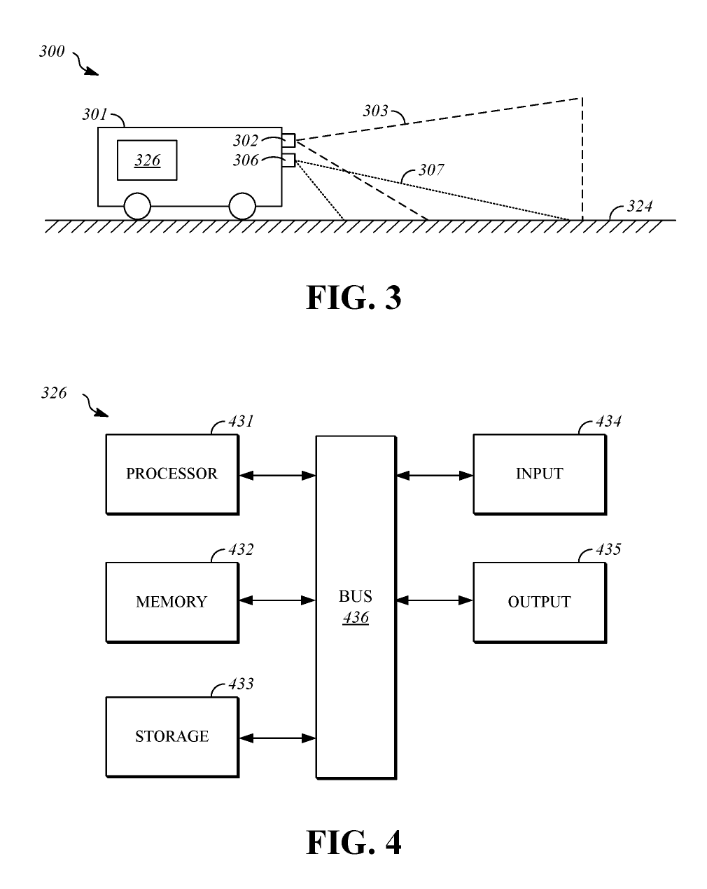

FIG. 4 is an illustration that shows an example of a hardware configuration of the computing device 326 that can be utilized to implement portions of the system 100, such as the functions described with respect to the correlator 110, the compression parameter determiner 114, and the encoder 118, and can be utilized as the computing device 326.

The computing device 326 may include a processor 431, a memory 432, a storage device 433, one or more input devices 434, and one or more output devices 435. The computing device 326 may include a bus 436 or a similar device to interconnect the components for communication. The processor 431 is operable to execute computer program instructions and perform operations described by the computer program instructions. As an example, the processor 431 may be a conventional device such as a central processing unit. The memory 432 may be a volatile, high-speed, short-term information storage device such as a random-access memory device. The storage device 433 may be a non-volatile information storage device such as a hard drive or a solid-state drive. The input devices 434 may include any type of human-machine interface such as buttons, switches, a keyboard, a mouse, a touchscreen input device, a gestural input device, or an audio input device. The output devices 435 may include any type of device operable to provide an indication to a user regarding an operating state, such as a display screen or an audio output.

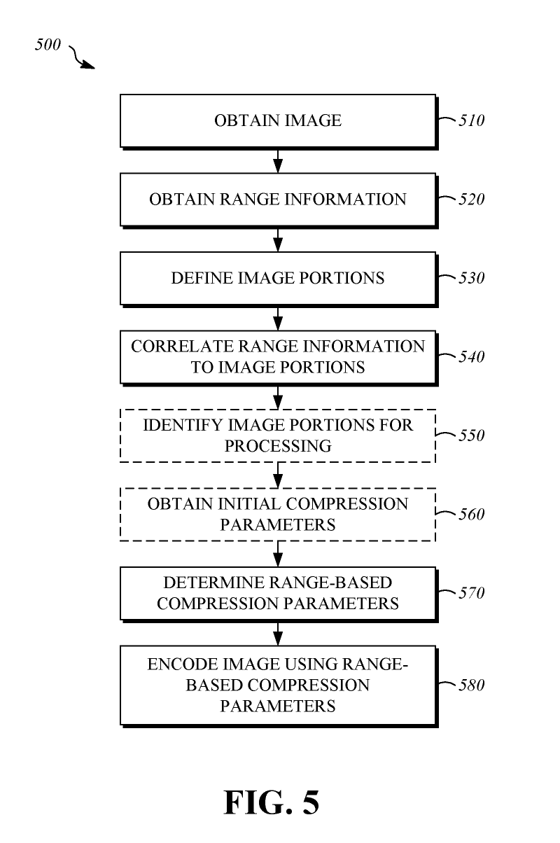

FIG. 5 is a flowchart that shows an example of a process 500 for image compression based on distance information. The process 500 can be performed using the system 100 of the system 300, and operations of the process can be caused, controlled, or performed by a computing device, such as the computing device 326. The computing device is provided with instructions that are stored in a storage device or a memory device, and a processor that is operable to execute the program instructions. When executed by the processor, the program instructions cause the computing device to perform the operations of the process 500 as described herein.

An image is obtained in operation 510. Obtaining an image can be performed using a sensor of any type that is suitable to output a signal representing a visual depiction of an environment near the sensor. As an example, the image sensor 102 can be utilized to generate the image 104, as described with respect to the system 100.

Range information is obtained in operation 520. Obtaining range information can be performed using a sensor of any type that is suitable to output a signal representing distances from the sensor to objects that are located in the environment near the sensor. As an example, the range sensor 106 can be utilized to generate the range information 108, as described with respect to the system 100.

Image portions are defined in operation 530 using the image that was obtained in operation 540. Any areas of the image can be utilized as image portions. As an example, the image portions can be groupings of pixels, blocks, or macroblocks, as described with respect to the image 104 and the correlator 110.

In operation 540, the range information that was obtained in operation 520 is correlated to the image portions that were defined in operation 530. Correlating the range information with the image portions can be performed as described with respect to the correlator 110 to define correlated range information.

In optional operation 550, portions of the image are identified for processing using distance-based compression. As one example, feature extraction techniques are utilized to identify portions of the image that correspond to known features. The image portions corresponding to known features can be flagged such that they are excluded from distance-based compression processing. Compression rates for these portions of the image can be unaltered relative to rates that would typically be set during encoding or can adjusted, such as by using predetermined compression parameter values or predetermined adjustments that are feature-based instead of distance based. An another example image portions can be excluded if there is insufficient range information or no range information available to determine a correlated range value. Compression rates for these portions of the image can be unaltered relative to rates that would typically be set during encoding or can be adjusted, such as by using predetermined compression parameter values or predetermined adjustments. Thus, for example, operation 550 can include identifying a first group of image portions to be processed using distance-based compression parameters and a second group of image portions that are not to be processed using distance-based compression parameters. The image portions from the second group of image portions are identified based on features present in the image portions from the second group of image portions, or based on absence of sufficient range information for the image portions from the second group of image portions, and range-based compression parameters are not used for the second group of image portions. Instead, solely image-based compression parameters, default compression parameter determining techniques, or predetermined compression parameters can be used.

In optional operation 560, initial compression parameters are obtained. The initial compression parameters can be based on the image that was obtained in operation 510, and can include individual parameters on a portion-by-portion basis for the image portions that were identified in operation 530. The initial compression parameters are not based on the range information that was obtained in operation 520. Instead the initial compression parameters can be determined by an encoder, as described with respect to the encoder 118 and the initial compression parameters 120, using conventional still image compression techniques or video compression techniques.

Range-based compression parameters are determined in operation 570. In some implementations, the range-based compression parameters affect an amount of spatial detail or chromatic detail for the image portions in the encoded image. In some implementations, the range-based compression parameters affect an amount of spatial resolution for the image portions in the encoded image. As an example, the range-based compression parameters can be quantization parameters. In implementations where the range-based compression parameters are quantization parameters, the quantization parameters decrease as distance values increase and the quantization parameters decrease as the distance values increase.

The range-based compression parameters can be determined in the manner described with respect to the compression parameter determiner 114, and can be determined with or without use of initial parameters from optional operation 560, in the manner previously described. In implementations where initial parameters are used, wherein determining range-based compression parameters includes receiving the initial values and modifying the initial values based on the distance values from the range information.

In operation 580, the image obtained in operation 510 is encoded using the range-based compression parameters that were determined in operation 570 to define an encoded image. Encoding the image portions of the image using the range-based compression parameters can cause image portions corresponding to large distance values to be compressed using low compression rates and causes image portions corresponding to small distance values to be compressed using high compression rates. Operation 580 can be performed in the manner described with respect to the encoder 118 of the system 100 to generate the encoded image 122.

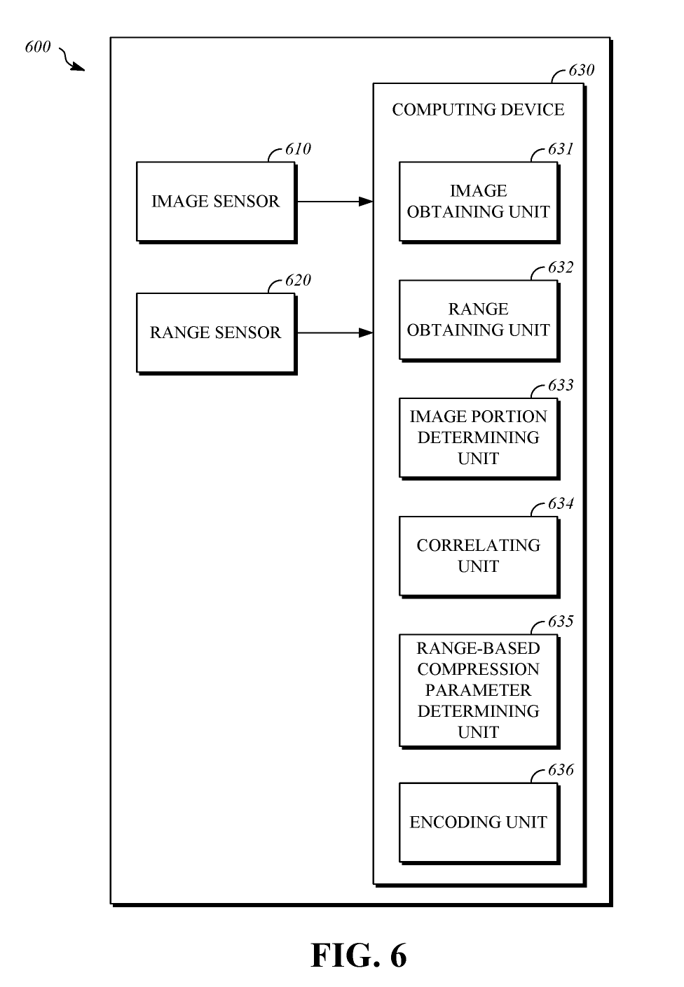

FIG. 6 is a functional block diagram showing an apparatus 600. The apparatus 600 includes an image sensor 610, a range sensor 620, and a computing device 630. The computing device 630 includes an image obtaining unit 631 operable to obtain an image from the image sensor 610. The computing device 630 includes a range obtaining unit 632 operable to obtain range information from the range sensor 620. The computing device 630 includes an image portion determining unit 633 that is operable to define image portions of the image that is obtained by the image sensor 610. The computing device 630 includes a correlating unit 634 for correlating range values from the range information that is obtained by the range sensor 620 to the image portions that are determined by the image portion determining unit 633. The computing device 630 includes a range-based compression parameter determining unit 635 for determining range-based compression parameters for image portions based on a distance value for each of the image portions such that compression rates applied by the range-based compression parameters are dependent on the distance values, and can be inverse to the distance values. The computing device 630 includes an encoding unit 636 for encoding the image portions using the range-based compression parameters from the range-based compression parameter determining unit 635 to generate an encoded image.

Persons of skill in the art will appreciate that operation of the units and devices of FIG. 6 can be further understood with reference to corresponding portions of the system 100 of FIG. 1, corresponding portions of the system 300 of FIG. 3, and corresponding operations of the process 500 of FIG. 5, and therefore, previously explained details are not repeated here.

What is claimed is:

1. A method, comprising:
determining range-based compression parameters for image portions based on a distance value for each of the image portions such that compression rates applied by the range-based compression parameters depend on the distance values; and
encoding the image portions using the range-based compression parameters to generate an encoded image, wherein the range-based compression parameters cause the image portions corresponding to large distance values to be compressed using low compression rates and cause the image portions corresponding to small distance values to be compressed using high compression rates.

2. The method of claim 1, wherein the range-based compression parameters affect at least one of an amount of spatial detail or an amount of chromatic detail for the image portions in the encoded image.

3. The method of claim 1, wherein the range-based compression parameters affect an amount of spatial resolution for the image portions in the encoded image.

4. The method of claim 1, wherein the image portions correspond to groups of pixels in the encoded image.

5. The method of claim 1, further comprising:
correlating the distance values to the image portions based on a geometric relationship between an image sensor and a range sensor.

6. The method of claim 1, wherein the range-based compression parameters are quantization parameters.

7. The method of claim 6, wherein the quantization parameters decrease as distance values increase and the quantization parameters decrease as the distance values increase.

8. The method of claim 1, wherein determining range-based compression parameters includes receiving initial values and modifying the initial values based on the distance values.

9. The method of claim 8, wherein the initial values are based on the image portions.

10. A method, comprising:
obtaining an image;
obtaining range information;
defining image portions from the image;
correlating the range information to the image portions to define correlated range values that each describe a distance that is associated with a respective one of the image portions; and
encoding the image to generate an encoded image using compression parameters for at least some of the image portions to apply a high compression rate to at least some of the image portions having correlated range values that correspond to short distances and to apply a low compression rate for at least some of the some of the image portions having correlated range values that correspond to long distances.

11. The method of claim 10, wherein the compression parameters affect an amount of spatial detail or an amount of chromatic detail for the image portions in the encoded image.

12. The method of claim 10, wherein the compression parameters affect an amount of spatial resolution for the image portions in the encoded image.

13. The method of claim 10, wherein the image portions correspond to groups of pixels in the encoded image.

14. The method of claim 10, wherein the compression parameters are quantization parameters.

15. The method of claim 10, further comprising:
determining the compression parameters based on the correlated range values.

16. The method of claim 15, further comprising:
determining the compression parameters based further on initial values that are based on the image portions.

17. A method, comprising:
obtaining an image;
obtaining range information;
defining image portions from the image;
identifying a first group of image portions from the image portions and a second group of image portions from the image portions;
correlating the range information to the image portions in the first group of image portions to define correlated range values that each describe a distance that is associated with a respective one of the image portions;
determining range-based compression parameters for the image portions in the first group of image portions based on the correlated range values; and
encoding the image portions using the range-based compression parameters for the first group of image portions to generate an encoded image.

18. The method of claim 17, wherein the image portions from the second group of image portions are identified based on features present in the image portions from the second group of image portions.

19. The method of claim 17, wherein the image portions from the second group of image portions are identified based on absence of range information for the image portions from the second group of image portions.

20. The method of claim 17, wherein range-based compression parameters are not used for the second group of image portions.
